(19) United States
(12) Patent Application Publication
(10) Pub. No.: US 2011/0125759 A1
(43) Pub. Date: May 26, 2011

(54) Method and system to contextualize information being displayed to a user

(75) Inventors: Laurent Quérel, Soisy sous Montmorency (FR); Guillaume Thonier, San Francisco, CA (US)

(73) Assignee: Yoono, Inc, San Francisco, CA (US)

(21) Appl. No.: 12/948,708

(22) Filed: Nov. 17, 2010

Related U.S. Application Data
(60) Provisional application No. 61/262,104, filed on Nov. 17, 2009.

(51) Int. Cl. G06F 17/30

(52) U.S. Cl. 707/748; 707/802; 707/E17.005; 707/E17.044

(57) ABSTRACT

Provided is a system and related methods for collecting and storing in a local storage the information extracted. The information stored in this step may include data extracted from the user's navigation on websites, data pushed to the user via his subscriptions to social networks, rss feeds, emails, and data representing the interaction of the user with the web browser and its content.

### RELATED APPLICATIONS

This application claims the benefit of U.S. Provisional Application No. 61/262,104, filed Nov. 17, 2009, the disclosure of which is incorporated by reference herein.

### BACKGROUND

The present invention relates to an advertising system and method using a web browser serving as an Internet surfing tool, specifically, to an advertising system and method using an Internet web browser, in which data is collected from the user's navigation, the user's social stream or the user's interaction with the browser and stored in a local storage, the content of which is made available to websites, their partners and browser extensions for the purpose of delivering contextual and personalized content to the user, specifically banner ads and dedicated web pages.

World Wide Web (WWW) documents (or web pages) are more and more used to display advertising: ads are everywhere and all internet users are often overwhelmed by ads that have no value to them. Popular websites such as news sites or blogs are often able to attract high paying advertisers who are willing to pay high amounts of money to simply be “in front of a user”. As a result most banner ads displayed on high-traffic web sites are irrelevant to a vast majority of users and greatly contribute to an advertising fatigue of sorts.

Many advertising companies (Ad Networks) have attempted to solve the issue using two different approaches: Profiling and Retargeting.
Profiling: this is the most typical approach to attempt to deliver relevant ads to a user. This method typically uses generic information about a Web site to infer properties about the user visiting this site. For example, if you visit a blog or a fan web site for a car manufacturer, advertisers will assume that you are a male, in a specific age group and that you are interested in wheels, tires and other car specific products. In some instances, ad networks go one step further in their profiling methodology by actually using actual demographic information about a user provided by the websites themselves. A typical example of such a profiling is what occurs on social networking sites such as Facebook, where advertisers can access information such as gender, age, marital status; as a result a single male in his thirties will often be presented with dating ads that are largely irrelevant to him, especially when showed excessively frequently.
Retargeting: this is an approach used by ad networks to deliver relevant ads to a user by attempting to track his/her activity on the web. The most common method today—used by almost all ad networks—is to drop several cookies on every site a user visits where he/she is exposed to a banner ad from the ad network. The cookies typically contains an id uniquely identifying a user and enough information to know what site the user was visiting and in some cases what portion of the site a user has been interacting with. When the user visits another site where the ad network has the ability to display a banner ad, this network can use information stored in the cookies to “retarget” the user and display more pertinent banners.

Both methods usually fail in correctly targeting the user because in both cases, the ad networks only see a partial view of who the user is. Because they are lacking the ability to track a user everywhere he/she goes, they can only guess what is most relevant to the user based on the sparse data they can access.

The invention described here addresses this shortcoming by providing comprehensive real-time data to ad networks and publishers alike.

### BRIEF DESCRIPTION OF THE DRAWINGS

FIG. 1. is a diagram depicting the mechanism of using the API to display personalized content in a web browser.

FIG. 2. is a diagram explaining how different types of data are extracted and stored.

FIG. 3. is a flow diagram explaining how n-grams are extracted and scored in a web page.

FIG. 4. is a flow diagram explaining how n-grams are extracted and scored in a stream of updates.

FIG. 5. is a flow diagram explaining the process of granting a website or other third party application access to the data.

### DETAILED DESCRIPTION OF THE DRAWINGS

The invention provides systems and methods configured to collect and store data that represent the user activity on the world wide web and to make it available to third parties to access this data and use it in their own algorithms to present targeted banner ads or personalized recommendations. The third parties have the option to either access the raw data or specify a filter and receive only data matching this filter.

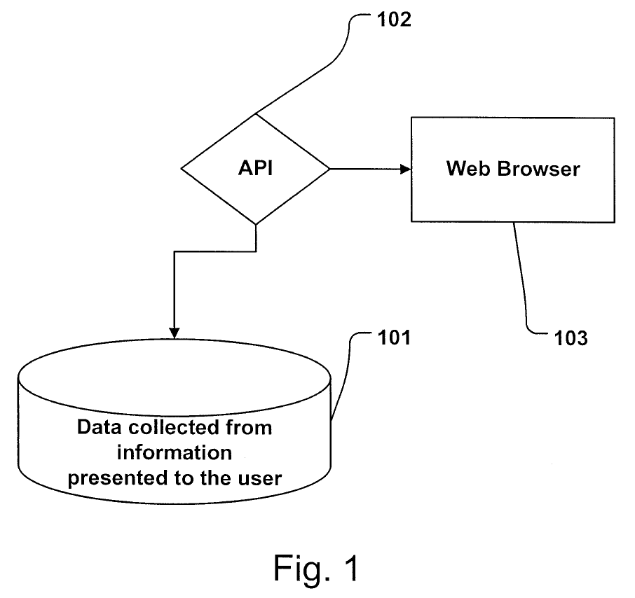

When a user navigates to a website or otherwise interacts with the browser, a need to display personalized content to the user can arise. The website may want to display a personalized web page with information relevant to the user (e.g: better personalized product recommendation on a shopping site, more relevant list of articles on a news site), or third parties applications or widgets hosted on the website may want to display more relevant or contextual content (e.g.: a banner ad). The browser itself or a particular browser add-on may also want to display a more personalized and contextual message to the user (e.g.: a browser add-on that gives recommendation on a webpage). The invention provides an API (FIG. 1) that lets these entities access data collected from the user experience within the browser. When the entities above call a function of the API, they can request raw data as well as filtered data and use it to display personalized information to the user.

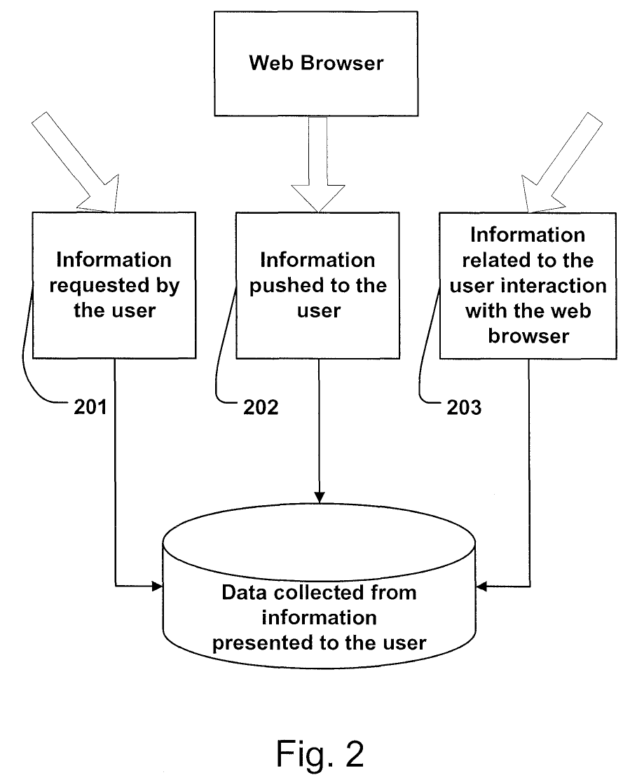

The data made available thru the API can be categorized in three ways: data extracted from the content of the websites visited by the user, data pushed to the user via his/her subscription to internet content—including but not limited to social networks activities (social stream), rss feeds, emails—, data collected while the user interacts with the browser. That data is then stored in a local storage (FIG. 2).

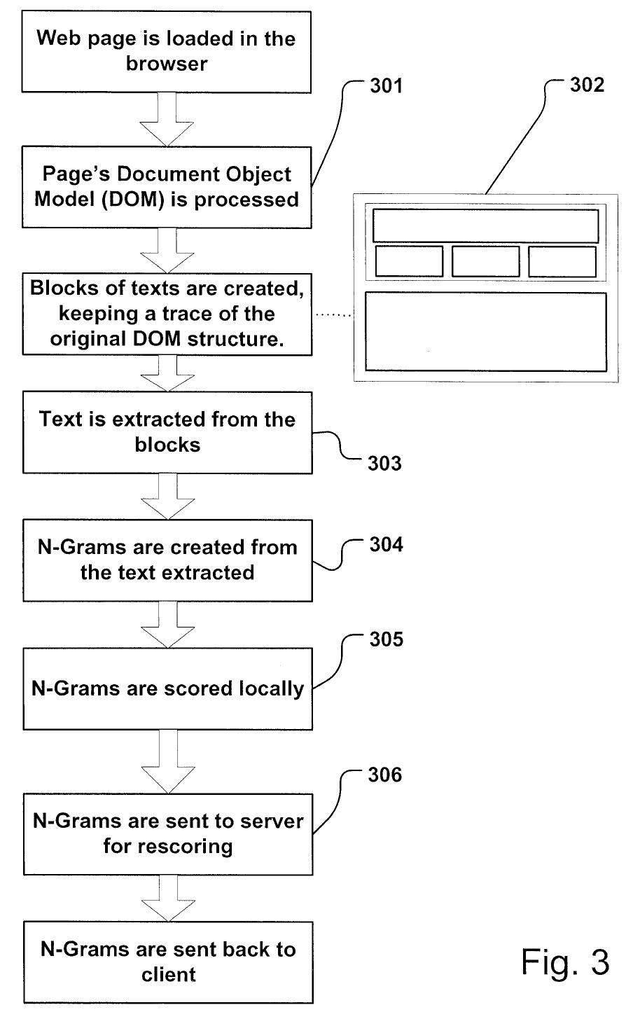

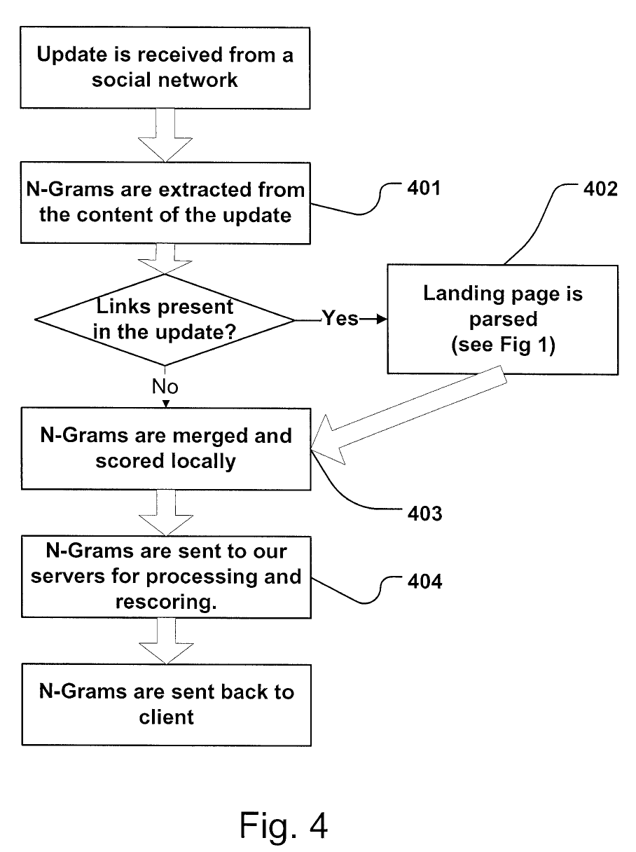

The data can be extracted from the website or the social stream in different ways, our invention describes a specific method to do so:
When a user navigates to a website, the content of the web page currently loaded is accessed by our technology via the page's Document Object Model (DOM), which is parsed, converted in sets of blocks and sublocks, the content of which is analyzed and segmented. After a series of algorithms, n-grams are assembled and ranked to represent what the page is about (FIG. 3).
A user's social stream is defined as the collection of messages, posts, comments generated by the user and the user's friends on social networking websites. Any website or service that provides a user with a continuous list of messages or other form of activity from the user's friend can be called social networking site or service. Any message or activity occurring on such a site or service would therefore be considered part of the user's social stream. A typical example is a friend's status update on Facebook or a post on Twitter of someone you follow. The invention uses specific algorithms to extract content from a social stream, identifying n-grams in the stream that represent the stream (FIG. 4).

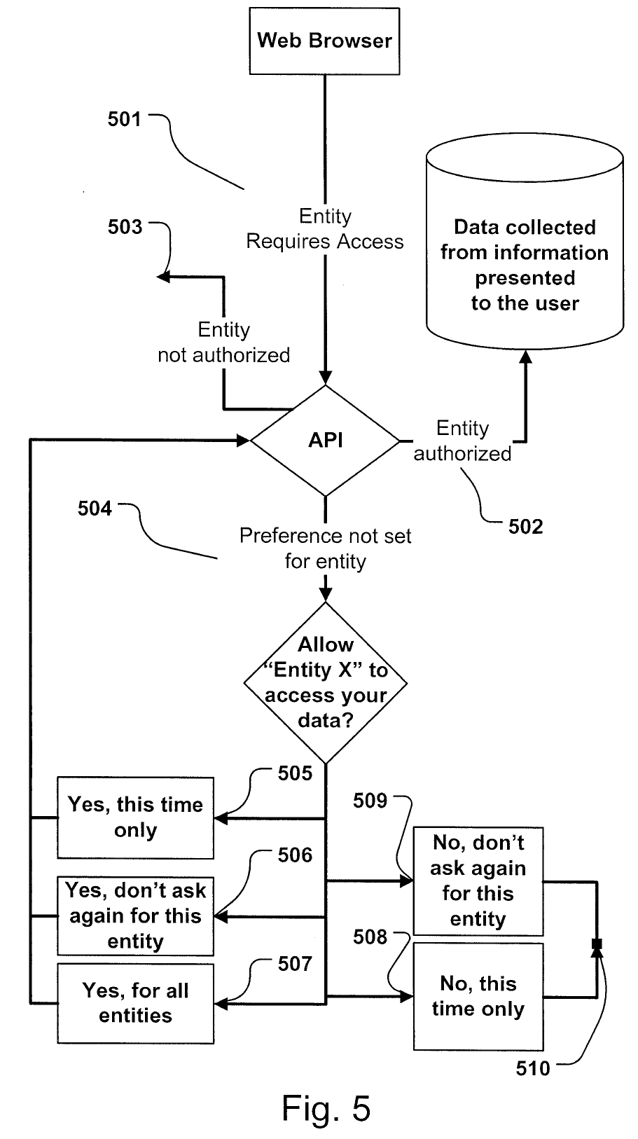

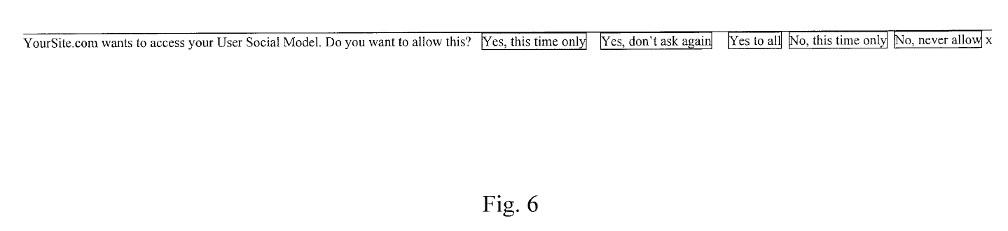

When an entity as described above needs to access the user collected data via the API, the user is exposed to a message asking him to authorize the entity to access his data. The user can choose to answer “Yes, this one time only”, “Yes, don't ask again for this entity”, “Yes, for all entities”, “No, this one time only”, “No, never authorize this entity”. This gives the user complete control on who can access his/her data (FIG. 5).

In FIG. 1. the data that has been collected and stored locally (101) is accessed by the web browser (103), either via a website, or a third party running on a website or possibly via a browser extension. An API (102) is used to return data relevant to the browser query. There are several ways in which the data can be filtered, including but not limited to:
by category: the browser can ask for data belonging to a specific category (e.g.: electronics, travel)
by time: the browser can ask for data collected in a specific time period (e.g.: past hour, past day, previous day between 8 am and 9 am)
by frequency: the browser can ask for data that are seen with a specific frequency (e.g.: every day, 5 times per hour.
   The local data storage can be implemented in several different ways as long as the information resides entirely on the user's drive. In the preferred implementation we rely on the browsers massive adoption of SQLite—a fully functional relational database using a single flat file storage and offering full-text search capabilities in most cases. Using this storage structure, we construct several tables to store the data, including but not limited to:
a table to store the n-grams extracted during the user navigation, including the frequency, score and information regarding the source of the n-grams (extraction, metadata . . . ).
a table to store the categories most browsed by a user, including a confidence score and frequency information.
a table to store the user interactions with the browser and the different activity feeds.

In FIG. 2. three distinct sources of information are being stored in the local storage. When a user navigates to a web page (201), information is automatically extracted from that page, including but not limited to:
metadata written in the page
microformats available in the page or equivalent information.
search terms used in search boxes if the page has any
the url of the page
n-grams automatically extracted from the content of the page
   When information is pushed to the user (202) via his/her subscription to social network feeds or rss feeds or emails, information is automatically extracted from that content, including but not limited to:
who sent the update
what source is responsible for the update (e.g.: Facebook, Gmail)
what type of update it is (e.g.: a message addressed to the user, a standard update not meant for anyone)
n-grams automatically extracted from the content of the update and any link present in the update
personal information about the sender or receiver including but not limited to: email, gender, date of birth, interests—when available.
   When the user interacts with the web browser (203) (e.g.: clicks on a button, scrolls down a page), this information is automatically recorded.

FIG. 3. describes the process of extracting n-grams from the content of a page. After a user visits a web page in his/her browser, the Document Object Model (DOM) is accessed and parsed (301). Several methods can be used to do so including but not limited to:
use an extension (sometimes called add-on or plugin) in the browser that asks for specific permission to the browser to access the user's navigation and its content.
use an extension in the browser that asks only to access the user navigation, not the content of the page and use a server side module to crawl the web and extract the content of the page. This method is obviously less reliable because the server would not have access to any content created specifically for the user, in particular if the page requires the user to login, the server will not have access to the correct content.
use a local executable to serve as a local proxy and spy on the network communications for example. Many other options are available since an executable can access almost anything on the user's computer.
use some embedded code on each page (this assumes a direct partnership with all or almost all web publishers, so not entirely likely but possible via embeddable objects such as Facebook “Like” buttons) to access the content of the page directly from inside the page.

The preferred method is to have the n-gram extraction technology be part of the browser—in our case as a browser add-on. This gives all the necessary permission to access the DOM of a page and all browser generated events. As the DOM is parsed, the algorithm optionally keeps information about the structure of the DOM, how many blocks (or html block structures) are present, how they relate to one another and how many levels to keep (302). In this system, element hierarchy is preserved. While parsing the page a tree of text block nodes, which also contain metadata such as tag name and class name of the node, is built up in a one-to-one correspondence with DOM nodes, which constitutes the new data structure that holds text as well as page structure information. The page data is stored in block objects that are linked together to form a tree. Each block has a pointer to its parent block (except the root block, which points to null) and an array of pointers to sub-blocks. The block objects also contain lots of metadata associated with that node. In order to make processing the tree more efficient trimming is done to reduce the number of irrelevant (empty) nodes. A node is considered empty if it contains no text and contains 0 or 1 sub-node. If a node is empty and is a leaf node it is simply deleted from the tree. If a non-leaf node is empty its sub-node is then added as a sub-node of the empty node's parent and the empty node is deleted from the tree. At this point the tree is traversed in order to propagate data about sub-nodes upwards to the root of the tree so that all nodes contain accurate aggregate data about its sub-tree. Virtually all metadata is updated except data about specific n-grams, which is separated out into a different routine. Once this representation of the DOM is created, the text portion of the structure is extracted from the blocks (303). N-grams are then extracted from the text (304). During this phase, the text is cleaned up and stopwords or otherwise non recognizable unigrams are removed. N-grams are assembled from the remaining contiguous unigrams. The next major step is to score and rank the n-grams created above (305), this is done locally and the algorithm uses a formula combining several parameters to score a n-gram, including but not limited to:
frequency of occurrence in a language corpus
frequency of occurrence in the page
frequency of occurrence in the blocks
spread amongst the blocks
size of the blocks in which it is present

In the preferred implementation, the algorithm begins by attributing a basic score for the remaining n-grams based on a simple tf/idf using a pre-computed local language corpus (typically created by extracting content from generic language sites such as Wikipedia.com). These basic scores are then modified using primarily two techniques:
a page focus algorithm
a block focus algorithm

The page focus is the part of the algorithm that extracts n-gram ranking information, from n-gram page density. The assumption is that the density of a word within the page, or subsection, is directly related to its importance to that area of text. Thus, many values of density can be interesting, depending upon what we DOM node is chosen as the root of the tree and the depth that is used. Currently only two cases are considered for density extraction:
Page Focus (PF): Here the algorithm looks at the page as a single document of two levels. Top level being the entire page, while the second level is any node with visible text.
Block Focus (BF): Here the algorithm looks at individual DOM blocks with daughter blocks. The DOM block must contain visible text, and at least one of its daughters contains visible text.

The important information input information for the PF and BF calculation are the n-gram counts for each DOM block and their parent/daughter relationships. This data must be gathered before the DOM blocks are turned into n-gram page counts for the base n-gram rankers. Maps are built for the PF and BF containing the n-gram occurrence per each DOM node with visible text. For each of the DOM nodes the algorithm looks to see if the text should be broken down into smaller textual sentiments (split on [,.;:!?]). From the above maps the algorithm can then calculate:
the number of blocks containing the n-gram
the number of times the n-gram appears
the total number of n-grams
the distinct number of n-grams

From these five distinct variables, the algorithm can then calculate the final discriminates that are used to modify the scores of n-grams. Two filters are used for this:

The Page Focus Filter is divided in two parts:
the individual n-gram Page Focus: it is the extracted average focus for an individual n-gram for the entire DOM.
the overall page focus: it is used to decide whether the individual n-grams are weighted by a normalized individual n-gram page focus. In essence the Overall Page focus is a weighted average of the individual n-gram page focus. The meaning of the response from the function is not linear, so a sigmoid function is used to better define this threshold.

When the Overall Page Focus falls between 0.3 and 0.65, the algorithm applies the normalized (0-1 scale) individual n-gram Page Focus to each n-gram. The range of 0.3 to 0.65 describes pages that have a decent amount of text (lower/minimum level), yet are not so dedicated to a small set of n-grams that the proper n-grams are already picked out by the rest of the KWE (higher level).

The Block Focus Filter is divided in three parts:
the percentage of sub-blocks used per block: it is the percentage of DOM blocks (with visible text) that have a Block Focus.
the Overall Differential Page Focus: the differential page focus is the ratio of the Overall Page Focus, to the Overall Page Focus not accounting for block break down from textual sentiment (splitting on [,.;:!?]). The more “document-like” a page is, the lower this number is
the Individual n-gram Average Block Focus: it is the average individual n-gram Block Focus. If there is no information on an individual n-gram (e.g.: if it is only found in leaf nodes), this value is the average of all n-grams with an individual Block Focus.

The algorithm requires that the Overall Differential Page Focus be less than 0.4 and more than 25% of the DOM blocks to be used to modify the n-gram score with the Individual n-gram Average Block Focus.

The n-grams are then optionally sent to a server (306) whose role is to enhance and improve the rankings of the n-grams if necessary, based on a specific demand (e.g.: modify the scoring to put the emphasis on movies). The role of the server is to provide the processing power and large amounts of information required to compute accurate recommendations, that are not available on the client. Domain-specific data is harvested server-side, either from client activity logs or third party sources, and compiled into descriptive databases and relationship graphs, using statistical methods. This compiled data resides as an index in the server memory. When a request is received from the client a process called “resolving” uses the databases to identify uniquely each element of information in the request. The sub-network of each identified element is then explored in the relation graphs, and potential matches are selected from the nodes in those graphs. Highly-modular and customizable selection heuristics are used to perform this selection. A set of filters determines which matches are finally accepted in this list and used to modify the rakings on the original n-grams. The matches influence the re-ranking in two ways:
different n-grams can be combined together server side, in which case their scores are combined.
new n-grams can be suggested in place of existing ones if the server as recommended that these new n-grams are better form of the original ones. In this case the score is untouched.

The third-party sources (or catalogs) mentioned above can also be used to create separate and very targeted indexes that can be used to produce “oriented” recommendations. In that scenario, the server has the ability to return some extra data along with the re-ranked keywords. This data could consist of links to entries in the catalogs that are most closely related to the n-grams it received. This information can also be stored in the local data storage and used by applications or websites to display ad-hoc recommendations to the user.

FIG. 4. describes the process of extracting n-grams from the content of an update in a social network (e.g.: Facebook, Twitter). After the update is being pushed to the user, we extract n-grams (401) from the content of the update using a technique similar to the one described in FIG. 3. If links are present in the update (402) the system parses the landing page using a technique identical to FIG. 3. and extracts n-grams from it. The scores of the newly extracted n-grams are then merged with the scores from the n-grams in the update (403). At this stage, the combined ranked n-grams are optionally sent to a server whose role is to enhance and improve the rankings of the n-grams (404).

FIG. 5. describes the process of asking the user to authorize a given entity (website, browser add-on, third-party application) to access his/her data via the API. When the entity needs to access the user data, it makes a query to the API (501). The query is similar to a query that would be made to the native APIs exposed by the browser (local storage, geolocation . . . ), we simply expose a new set of functions. Using a standard notation, some of the functions could look as follow:
yoono.usermodel.getTopKeywords(beginDate, endDate) which would return a list of top scored keywords for a given time period.
yoono.usermodel.getTopCategories(beginDate, endDate) which would return a list of top scored categories for a given time period.
yoono.usermodel.getRelatedKeywords(urls, keywords) which would return a list of keywords related to a given list of keywords or a given list of urls.
yoono.usermodel.getRelatedCategories(urls, keywords) which would return a list of categoris related to a given list of keywords or a given list of urls.
yoono.usermodel.getRelatedProducts(urls, keywords, merchants) which would return a list of products for a given set of merchants, related to a given list of keywords or a given list of urls.
   This list is non exhaustive and is just a small illustration of what can be done with the API.

The API then checks if the entity has been authorized to access the data in the context of the query. If allowed (502), the API accesses the storage and extracts the data requested by the entity. If not allowed (503), the API simply returns an error. If no preference has been set yet for the entity in the context of the query, the API proceeds to ask the user if he/she will authorize the entity to access his/her data (504). The user is presented with a banner at the top of the current page (see FIG. 6 for an example), asking him “XXX wants to access your User Social Model. Do you want to allow this?” where XXX describes the entity requesting access. The dialog contains a link labeled “More Info” that opens a new page explaining in details what the User Social Model is.

Possible categories of answer are:
“Yes, this time only” (505): this means that the user authorizes the entity to access his/her data but one time only (e.g.: for the current internet session only), which means that the entity will have to ask again when the context of the query changes.
“Yes, don't ask again for this entity” (506): this means the user permanently authorizes the entity to access his/her data. The entity will therefore not have to ask for the user's permission ever again.
“Yes, for all entities” (507): this means the user permanently authorizes this entity and all others to access his/her data. The user will never be asked again to authorize any entity.
“No, this time only” (508): this means the user denies the entity access to his/her data but one time only (e.g.: for the current internet session only), which means that the entity will be allowed to ask again for permission to access the user's data once the context of the query has changed.
“No, never authorize this entity” (509): this means the user permanently denies this entity access to his/her data. The entity will no longer be authorized to ask the user for permission to access his/her data.
   In cases 505, 506 and 507, the API can proceed to access the storage and extracts the data requested by the entity. In cases 508 and 509, the entity has been denied access to the user's data and an error is simply returned to the entity (510).

As discussed herein, the invention may involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Although the components and modules illustrated herein are shown and described in a particular arrangement, the arrangement of components and modules may be altered to perform analysis and configure content in a different manner. In other embodiments, one or more additional components or modules may be added to the described systems, and one or more components or modules may be removed from the described systems. Alternate embodiments may combine two or more of the described components or modules into a single component or module.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art. Accordingly, the specification and drawings are to be regarded in an illustrative rather than a restrictive sense.

Reference in the specification to “an embodiment,” “one embodiment,” “some embodiments,” “various embodiments” or “other embodiments” means that a particular feature, structure, or characteristic described in connection with the embodiments is included in at least some embodiments, but not necessarily all embodiments. References to “an embodiment,” “one embodiment,” or “some embodiments” are not necessarily all referring to the same embodiments. If the specification states a component, feature, structure, or characteristic “may,” “can,” “might,” or “could” be included, that particular component, feature, structure, or characteristic is not required to be included. If the specification or Claims refer to “a” or “an” element, that does not mean there is only one of the element. If the specification or Claims refer to an “additional” element, that does not preclude there being more than one of the additional element.

What is claimed is:

1. A system for collecting and storing in a local storage the information extracted, wherein the information stored in this step includes: data extracted from the user's navigation on websites, data pushed to the user via his subscriptions to social networks, rss feeds, emails, and data representing the interaction of the user with the web browser and its content.

2. A method for extracting data from a web page visited by a user comprising the steps of:
accessing loaded content of the web page via the document object model (DOM) of the web page,
parsing the content of the page to analyze the structure of the document,
converting the content into a hierarchical set of blocks and sub blocks (tree),
segmenting the content of each block into n-grams, scoring, ranking; and
selecting the n-grams that best represent the web page.

3. A method for extracting data from a user's social stream comprising the steps of:
accessing the content of the social stream via an API provided by each service,
parsing the content of each entry in the social stream,
extracting data from any and all link included in each entry using the method;
segmenting the body of each entry into n-grams,
scoring, ranking and selecting the n-grams that best represent the entry.
